(19) United States
(12) Patent Application Publication
(10) Pub. No.: US 2012/0035365 A1
(43) Pub. Date: Feb. 9, 2012

(54) Method for Manufacturing Porous Materials from Waste PET Bottle

(75) Inventors: Sue-Lein Wang, Hsin Chu City (TW); Yu-Ting Huang, Xinying City (TW)

(73) Assignee: National Tsing Hua University, Hsin Chu City (TW)

(21) Appl. No.: 13/041,441

(22) Filed: Mar. 7, 2011

(30) Foreign Application Priority Data
Aug. 6, 2010 (TW) 099126389

(51) Int. Cl. C07F 3/06

(52) U.S. Cl. 546/2; 556/118

(57) ABSTRACT

A method for manufacturing porous material from waste PET bottle, the method comprising: providing transition metal or d¹⁰ metal source, amine source, polyethylene terephthalate (PET) source, phosphate derivative source, and water to be reacted in a closed container under temperature between 120 to 200° C., and pressure between 1 to 100 atm for between 48 to 168 hours, for forming a reaction mixture; and precipitating the porous material from the reaction mixture. The method of the present invention uses the PET bottle polymers adequately to release two monomers in the reaction effectively and form porous or laminar material, such that the porous material can have photoluminescent phenomenon and can have light performance from white light to yellow-orange light under various excitation sources.

### CROSS REFERENCE TO RELATED APPLICATION

This present application claims priority to TAIWAN Patent Application Serial Number 099126389, filed on Aug. 6, 2010, which are herein incorporated by reference.

### TECHNICAL FIELD

The present invention is generally related to the field of a recycling PET, and more particularly to a method for manufacturing porous materials from waste PET bottle.

### BACKGROUND OF THE RELATED ART

Polyethylene Terephthalate (PET) material is widely applied in various packs and containers of the food and other commodities. According to the statistics, the consumption of PET bottle is about ˜30 million tons every year around the world, which is equivalent to about 1 trillion PET bottles. In the face of such a large quantity of waste PET, how to recycle and reuse the PET bottle is an important issue for the industry.

For example, the prior art has used the recycled PET (also known as R-PET) for applying to the textile industry by the mechanical process, or for re-making the containers or the bottles (also known as R-PET bottle). Based on the carbon chain of the polymer is strong and, it is relatively difficult to break, weaken or degrade the carbon chain into small molecules. Thereby, there are only 4% PET recycling method use the chemical method to break down the PET into monomers directly, or add other oligomer, to form another polymer materials for applying to the petrochemical industry of the resin-coated. For example, the purpose of the prior art is to extract the monomer of terephthalic acid (TA) from recycled PET bottles which has more economic value.

However, no matter what the method is, the aforementioned processes consume more energy and additionally increase the carbon dioxide exhaustion. In addition, the processes had only limited the monomers recycling and the textile recycling, which has relatively lower economic value. Therefore, under the low profit situation to recycle the PET, it is a negative effect to promote the environmental protection.

As above mentioned, a recycling method for waste PET which has greater economy benefit is in demand. Therefore, the present invention provides a method for manufacturing porous material from waste PET bottle.

### SUMMARY

One object of the present invention is to provide a method for manufacturing porous material from waste PET bottle to offer relatively higher economic value of recycling PET. In a preferred embodiment, the waste PET recycles to produce the white phosphor of single-emitting-component (SEC).

The present invention provides a method for manufacturing porous material from waste PET bottle, the method comprises steps of providing the transition metal or d¹⁰ configuration metal source, amine source, PET source, phosphate derivative source, and water to be reacted in a closed container under temperature between 120 to 200° C., and pressure between 1 to 100 atm for between 48 to 168 hours, for forming a reaction mixture; and the porous material is precipitated from the reaction mixture.

The present invention provides a porous material, the porous material is made by the above mentioned method, wherein the transition metal or d¹⁰ configuration metal source is Zinc source and the amine source contains pyridine group, such as 4,4′-trimethylenedipyridine (TMDP).

The present invention provides a porous material, the porous material is transition metal or made by the above mentioned method, wherein the d¹⁰ metal source is Zinc source and the amine source is alkyl polyamine, such as Tris(2-aminoethyl)amine (TREN).

### BRIEF DESCRIPTION OF THE DRAWINGS

FIG. 1A illustrates a diagram of the NTHU-2 chemical constitution of the prior art;

FIG. 1B illustrates a diagram of the NTHU-3 chemical constitution of the prior art;

FIG. 2 illustrates a method for manufacturing the porous material from waste PET bottle in accordance of the embodiment of the present invention;

FIG. 3A illustrates a diagram of the NTHU-2_{PET} chemical constitution in accordance of the embodiment of the present invention;

FIG. 3B illustrates a diagram of the TMDP which acts as protonated organic templates residing in extra-large channels within the NTHU-2_{PET} structure in accordance of the embodiment of the present invention;

FIG. 3C illustrates a diagram of the BDC(1,4-benzenedicarboxylate) ligands as pillars within the NTHU-2_{PET} structure in accordance of the embodiment of the present invention;

FIG. 3D illustrates a diagram of the NTHU-3_{PET} chemical constitution in accordance of the embodiment of the present invention;

FIG. 3E illustrates a diagram of the TREN which acts as protonated organic templates within the NTHU-3_{PET} structure in accordance of the embodiment of the present invention;

FIG. 3F illustrates a diagram of the TA of NTHU-3_{PET} chemical constitution in accordance of the embodiment of the present invention;

FIG. 4 illustrates a diagram of the TA recycling condition in accordance of the embodiment of the present invention;

FIG. 5 illustrates an X-ray diffraction pattern of NTHU-3_{PET} dissolved in different solvents in accordance of the embodiment of the present invention;

FIGS. 6A and 6B illustrates a photo-luminescent spectrometry diagram of NTHU-2_{PET} in accordance of the embodiment of the present invention.

### DETAILED DESCRIPTION

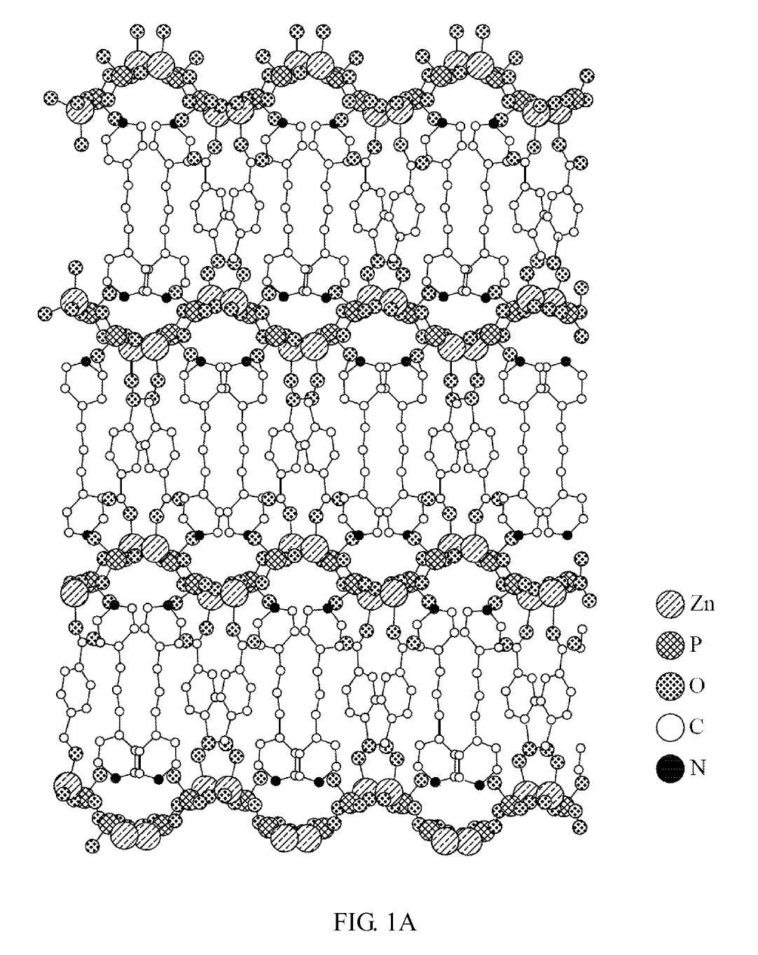

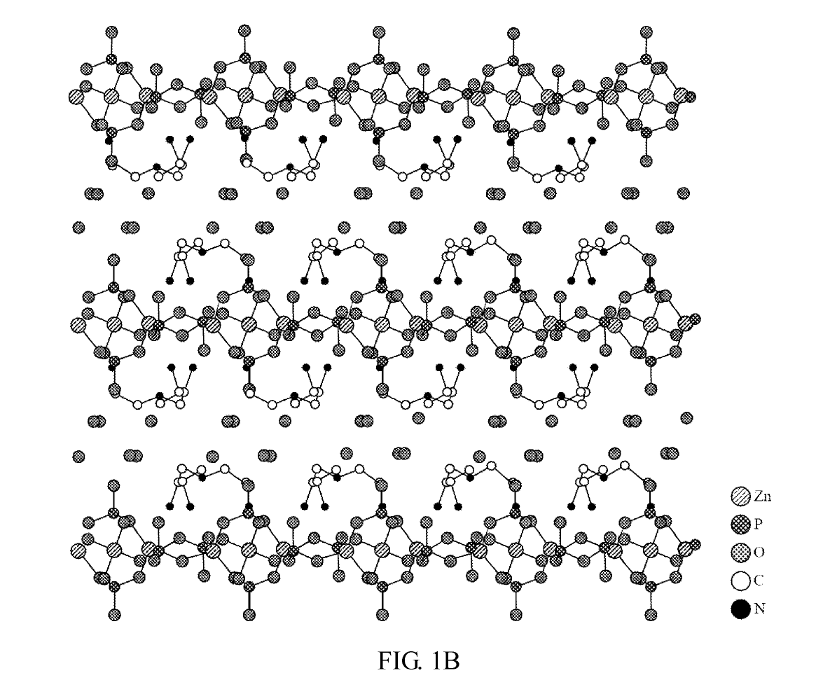

The porous material mentioned herein is generally speaking only a material having void spaces (pores) inside and/or on surface. For example, the porous material includes but not limited the NTHU-X material which is named by National Tsing Hua University (NTHU). For example, the structure of NTHU-2 is shown as in FIG. 1a and the structure of NTHU-3 is shown as in FIG. 1b.

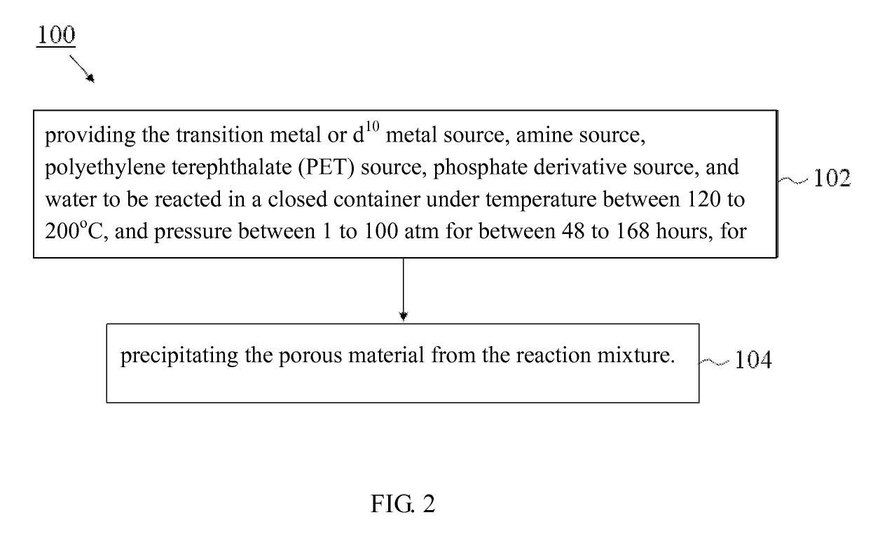

As shown in FIG. 2, the embodiment of the present invention provides a method 100 for manufacturing porous material from waste PET bottle. The method includes the following steps of providing the transition metal or d¹⁰ configuration metal source, amine source, PET source, phosphate derivative source, and water in a close container to act as reactants. The reaction of these reactants will be controlled under temperature between 120 to 200° C., and pressure between 1 to 100 atm for around 48 to 168 hours. A reaction mixture is finally prepared after the step 102. The porous material is subsequently precipitated from the reaction mixture at step 104. In another embodiment, the PET source is from reagent.

In preferred embodiment, in the step 104, hydrothermal process is introduced to the reaction mixture to crystallize the porous material, more particularly, the insoluble material will be digested by the aforementioned reaction conditions and through the temperature difference convection, and thereby the porous material emerges from the reaction mixture after a certain period of time.

In the preferred embodiment, the conditions for the method 100 is preferably under temperature 160° C. and about pressure >1 atm for about 72 hours.

In preferred embodiment, transition metal or d¹⁰ configuration metal source includes zinc containing source, manganese containing source, chromium containing source or other d¹⁰ configuration metal.

In a preferred embodiment, the zinc source includes Zn metal, ZnCl₂, Zn(NO₃)₂.6H₂O, ZnO₂ or the like.

In a preferred embodiment, the amine source includes pyridine or alkyl polyamine, such as Tris(2-aminoethyl)amine (TREN), 4,4′-trimethylenedipyridine (TMDP) or the like.

In one preferred embodiment, the phosphate derivative source includes phosphoric acid, phosphorous acid, hypophosphorous acid, hypophosphorous acid or the like.

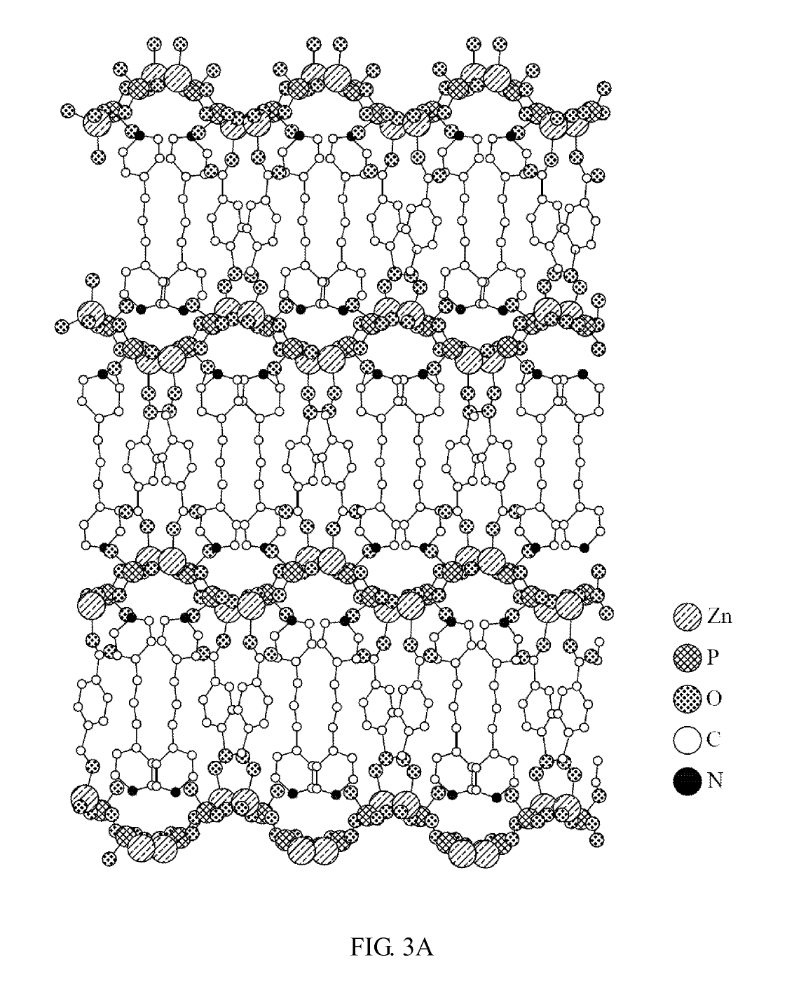

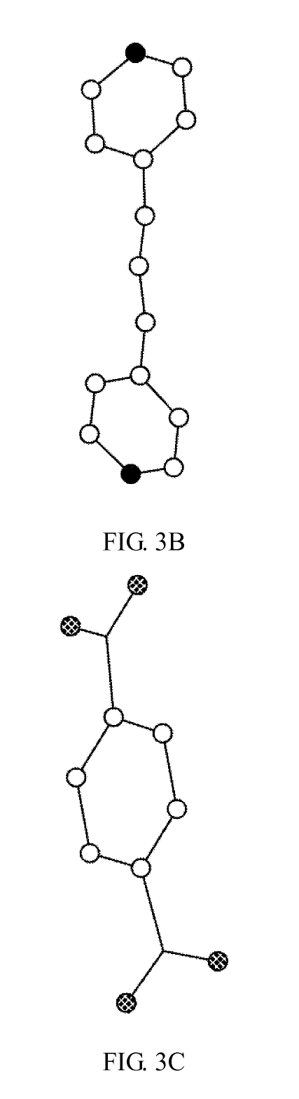

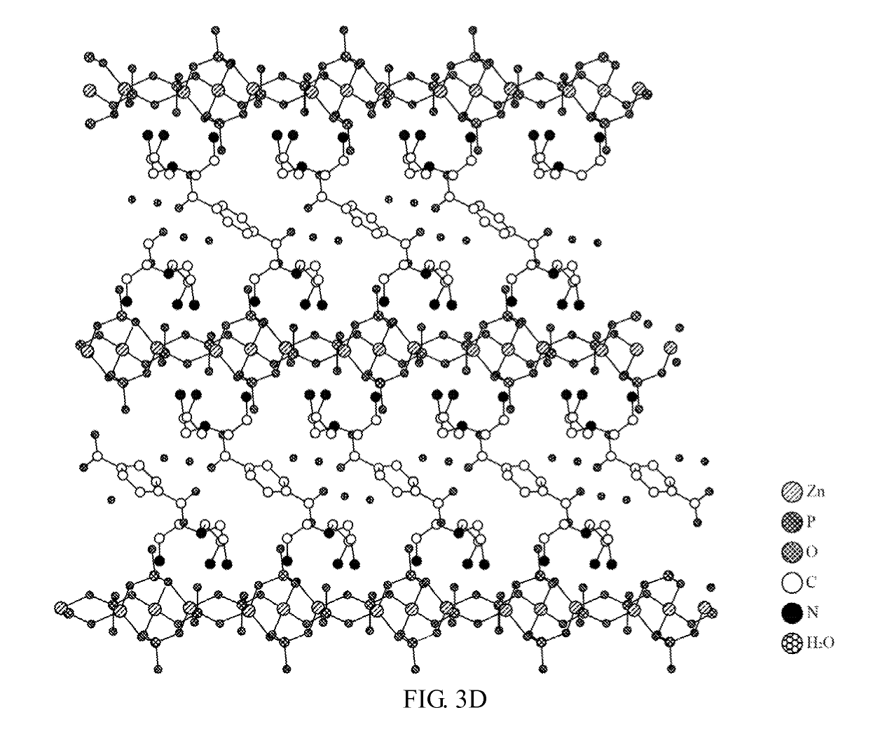

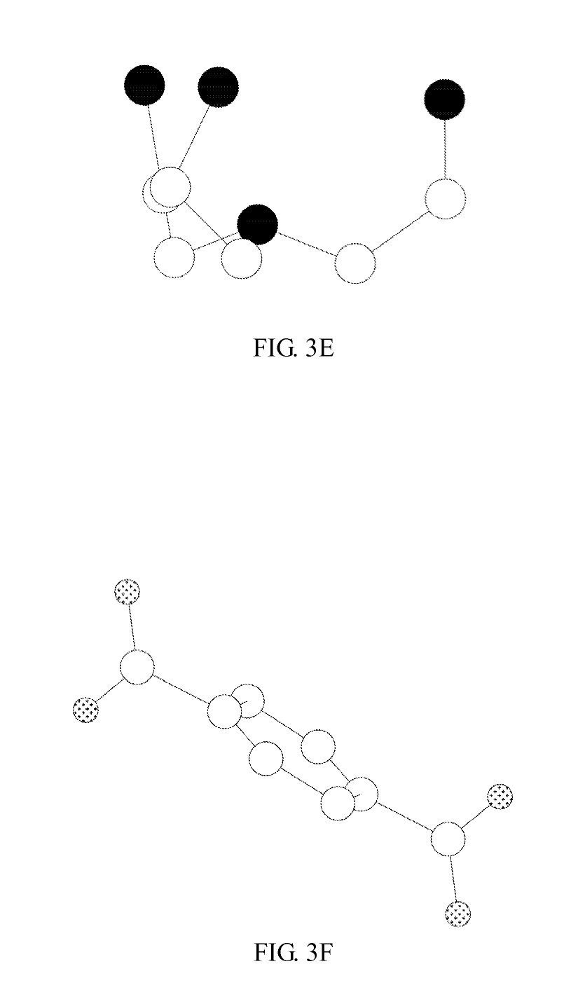

In preferred embodiment, the porous material (H₃TREN)₂[Zn₃(PO₄)₂](TA)(H₂O)₂ (hereinafter referred to as NTHU-3_{PET}) is manufactured at first. As shown in FIG. 3D, an organic-inorganic hybrid material-NTHU-3_{PET} which is composite of TREN (shown in FIG. 3E) within the inorganic layer Zn₃(PO₄)₂. The tri-protonated TREN functions as a template and it achieves the status of charge balance with the inorganic layer Zn₃(PO₄)₂ to form a pseudo neutral layer which is filled with TA shown in FIG. 3F and water.

In FIG. 3D, TA and water molecules separately exist in-between NTHU-3 layers. Furthermore, the manufactured porous material also could be (H₂TMDP)[Zn₂(HPO₄)₂(BDC)] (hereinafter referred to as NTHU-2_{PET}), as shown in FIG. 3A. Each ZnO₄ tetrahedron of the inorganic layer is corner-share with three HPO₄ tetrahedrons respectively by three oxygen atoms, A [4,8²] two-dimensions inorganic layer is formed by the three connected tetrahedrons. In FIG. 3C, The framework structure consists of neutral sheets of metal phosphate which are pillared through BDC anions to form extra-large pore in which 4,4′-trimethylenedipiridine cations are located. For example, TMDP as shown in FIG. 3B, are filled in the inorganic layer to achieve the charge balance of whole structure. If the cations are removed, a nano-tunnel which is 1.30 nm×0.65 nm could be observed. The hydrogen atoms in FIG. 3A to 3F are omitted.

In an embodiment of the present invention, the chemical reaction for NTHU-3_{PET} is

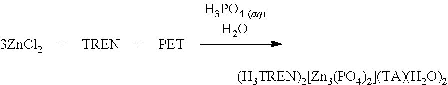

The above reaction is not limited to a specific dosage and ratio, wherein TREN is Tris(2-aminoethyl)amine. In a preferred embodiment, if ZnCl₂ 1 mmol, TREN 4 mmol, PET 0.3 g, H₃PO₄ solution 6 mmol (i.e. concentration 85%, 0.405 mL), H₂O 5 mL, then (H₃TREN)₂[Zn₃(PO₄)₂](TA)(H₂O)₂ 0.3105 g can be generated. The yield of the embodiment is about 86.49% and the rate of PET consumption is about 100%. In most of the embodiment, the product is (H₃TREN)₂[Zn₃(PO₄)₂](TA)(H₂O)₂. If zinc source is Zn(NO₃)₂.6H₂O which has six lattice waters, it could generate (H₃TREN)₂[Zn₃(PO₄)₂](TA)(H₂O)₂ and (H₃TREN)₂[Zn₃(PO₄)₂](TA), wherein (H₃TREN)₂[Zn₃(PO₄)₂](TA) (H₂O)₂ is 0.3418 g.

In further embodiment of the present invention, the chemical reaction formula of NTHU-2_{PET} is:

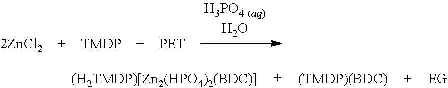

The above reaction formula is not limited to specific dosage and ratio, wherein BDC is 1,4-Benzenedicarboxylate and EG is ethylene glycol. In the preferred embodiment, if ZnCl₂ 1 mol, TMDP 6.4 mol, PET 0.5 g, H₃PO₄ solution 6 mmol (i.e. concentration 85%, 0.405 mL), H₂O 5 mL, it could produce (H₂TMDP)[Zn₂(HPO₄)₂(BDC)] and (TMDP)(BDC). The consumption rate of the PET is about 98%. The (TMDP)(BDC) byproduct is dissolved by HCl, and then it could recovered TA in 76%. More details about the (TMDP)(BDC) byproduct used to recycle the terephthalic acid (TA) are provided in following description.

Table 1 lists the crystal apparent, shape, size and reliability factors for the structures of NTHU-2_{PET} and NTHU-3_{PET} prepared from the method of the present invention. In order to provide comparison, NTHU-2 and NTHU-3TA.H₂O made by conventional synthesis are enclosed. Table 1 as follows:

TABLE 1

| | | | Reliability |
|---|---|---|---|
| | Crystal mophology | size (mm³) | factors |
| NTHU-2 | Lamellar; orange | 0.28 × 0.53 × 0.03 | R1 = 0.0766 |
| | | | R2 = 0.2230 |
| NTHU-2_{PET} | Columnar; orange | 0.5 × 1.2 × 0.23 | R1 = 0.0514 |
| | | | wR2 = 0.1496 |
| NTHU- | Lamellate hexagon; | 0.35 × 0.43 × 0.01 | R1 = 0.0463 |
| 3TA•H₂O | colorless | | wR2 = 0.1340 |
| NTHU-3_{PET} | Lamellate hexagon; | 1.48 × 1.6 × 0.25 | R1 = 0.0341 |
| | colorless | | wR2 = 0.0716 |

As shown in Table 1, the NTHU-2_{PET} made by the method 100 has better crystallization. The size of which is about 30 times the size of NTHU-2 and the actuarial structure reliability factors R1 and wR2 of NTHU-2_{PET} are also smaller than the ones of NTHU-2. Similarly, the NTHU-3_{PET} made by the method 100 has preferred crystallization. The size of which is about 400 times the size of NTHU-3TA.H₂O and the actuarial reliability factors R1 and wR2 of NTHU-3_{PET} are both smaller than the R factors of NTHU-3TA.H₂O.

In general, the crystal with larger size has better crystal quality. The smaller the R factors R1 and wR2 the more reliable the structure is. Therefore, Table 1 could evidence that the size and the reliability factors of the crystal, for instance, NTHU-2_{PET} and NTHU-3_{PET} made by the method 100 is better than the conventional crystallization method. In summary, although the chemical structure of NTHU-2_{PET} is essentially the same as NTHU-2, the crystal quality of NTHU-2_{PET} generated by the method 100 is largely improved as compared to NTHU-2.

In other words, the conventional method for manufacturing NTHU-2 could not obtain exactly the same the crystal quality as NTHU-2_{PET}. On the other hand, the crystal quality of NTHU-3_{PET} is not exactly the same as NTHU-3TA.H₂O. Therefore, the present invention provides a porous material called NTHU-2_{PET} that is generated by the method 100. The present invention also offers the method for producing further porous material called NTHU-3_{PET}.

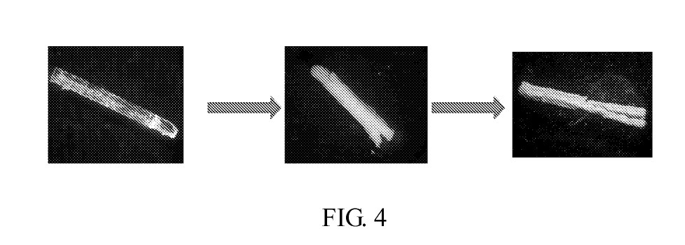

Take NTHU-2_{PET} as an example, the recycling economical value of a trivial waste PET bottle with 30 g and 600 mL is originally none, but under the present novel method, it could be effectively equivalent to about 300 mL EG and 24 g of terephthalic acid (TA) molecules for manufacturing porous material with higher economical value and producing the byproducts. FIG. 4 illustrates the byproduct (TMDP)(BDC) of the NTHU-2_{PET} made by the method 100 and the byproduct (TMDP)(BDC) is a co-crystal product. After dissolving by HCl, TA is precipitated and could be observed in the right one of FIG. 4. Therefore, in the preferred embodiment of the present invention, the byproduct (co-crystal) recycle rate of TA is more than about 72%. In another words, under the method 100 for manufacturing the NTHU-2_{PET}, most of the residual TA could be precipitated from the byproduct to recycle TA. Comparatively, the conventional method for NTHU-2 fails to produce the byproduct mentioned above; it needs to soak NTHU-2 for more than about 5 days to crystallize the co-crystal.

As shown in above chemical reaction formula of NTHU-2_{PET}, in the preferred embodiment, 0.5 g waste PET may create 5 mL EG solvent and 0.4 g TA. In turning of the market values of TA and EG, the manufacture of NTHU-2_{PET} could save costs about US $8 by the usage of 600 mL waste PET bottles with mean weight of 30 g in chemical reaction.

In an embodiment, if the waste PET is prepared with specific ratio to replace the conventional TA by the present method to produce NTHU-3_{PET}, almost 100% PET would be consumed. As shown in above chemical reaction formula of NTHU-3_{PET}, in an embodiment, the economical value of 0.3 g waste PET is equal to the one of 1 mmol TA for forming 0.3105 g (H₃TREN)₂[Zn₃(PO₄)₂](TA)(H₂O)₂. In turning of the market economical value of TA, it could save the cost of about 1 US dollars by using a 600 mL waste PET bottle with mean weight of about 30 g.

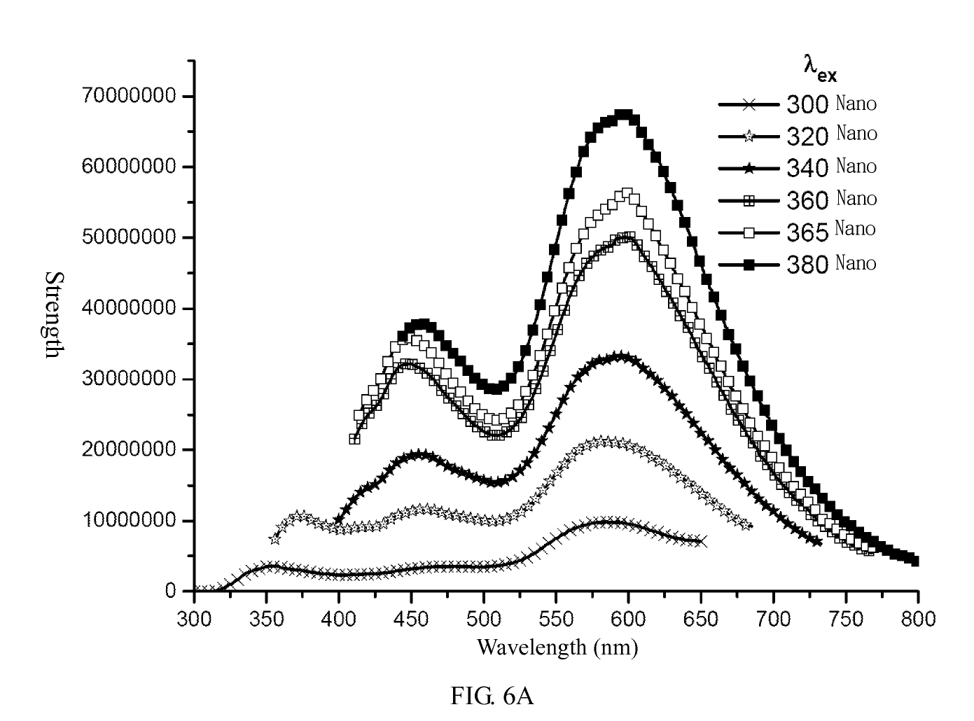

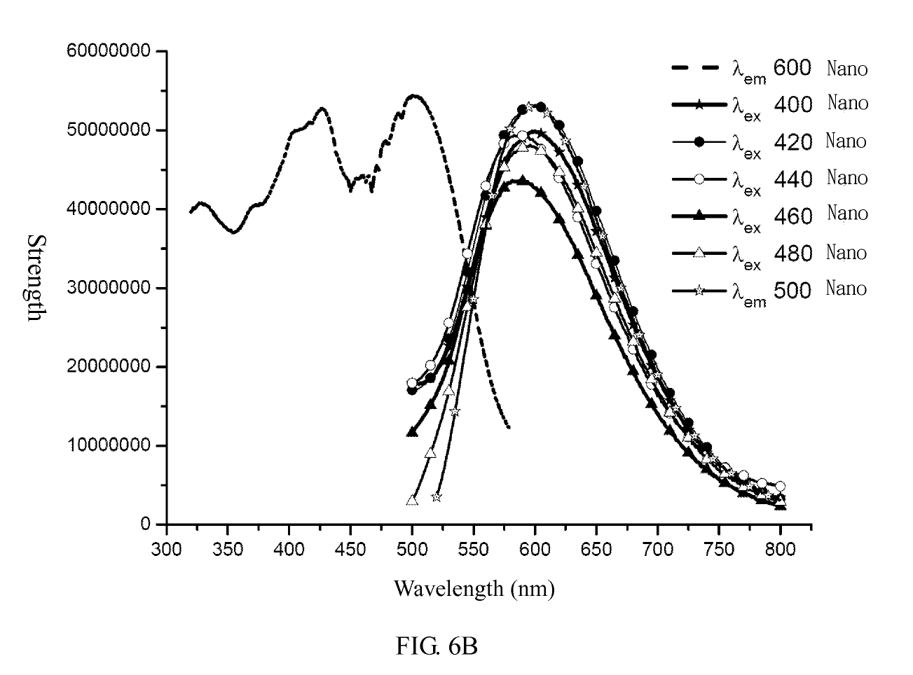

FIGS. 6A and 6B illustrate the photo-luminescent spectrometry diagram of NTHU-2_{PET} excited by various wavelength of the excitation light source from white light to yellow-orange light in accordance with different positions of the excitation spectrum.

As shown in FIGS. 6A and 6B, NTHU-2_{PET} generated by the method 100 could be applicable to broad wavelength range of the excitation light source. For example, the exciting light from 300 nm to 420 nm wavelength could allow the NTHU-2_{PET} emit the white light; and the exciting light from 440 nm to 480 nm could allow NTHU-2_{PET} emit the yellow light, wherein while the excitation light wavelength is about 365 nm, NTHU-2_{PET} emits the relatively pure white light. Hence, NTHU-2_{PET} generated by the method 100 has function as a white light phosphor LED of the single-emitting-component (SEC). The advantage of white light phosphor LED includes the characteristics of preventing the device from the internal color balance issues caused by mixing multi-color lights to generate the while light. At the time of the application, the existed SEC white phosphors are quite rare, and it could not be manufactured from waste PET as the present invention.

One of the advantages of the present invention is to provide a preferred way to recycle the waste PET, especially the bottles of plastic numbered by one.

Another advantage of the present invention is that the NTHU-2_{PET} has potential to functions as a white light phosphor LED of SEC. The cost for manufacturing the white light LED of SEC is significantly reduced due to the cost of the waste PET recycling is inexpensive.

Another advantage of the present invention is that the crystalline properties of NTHU-2_{PET} and NTHU-3_{PET} are superior to original NTHU-2 and NTHU-3. For example, both have the larger crystal size and the smaller reliability factors.

Another advantage of the present invention is that the method of recovering TA is easy for NTHU-2_{PET} and NTHU-3_{PET}. For example, the residual TA would form the co-crystal byproduct spontaneously to facilitate to recover TA. In some embodiments, there are about 72% TA could be recovered from co-crystals which are the byproduct in the method of manufacturing NTHU-2_{PET}.

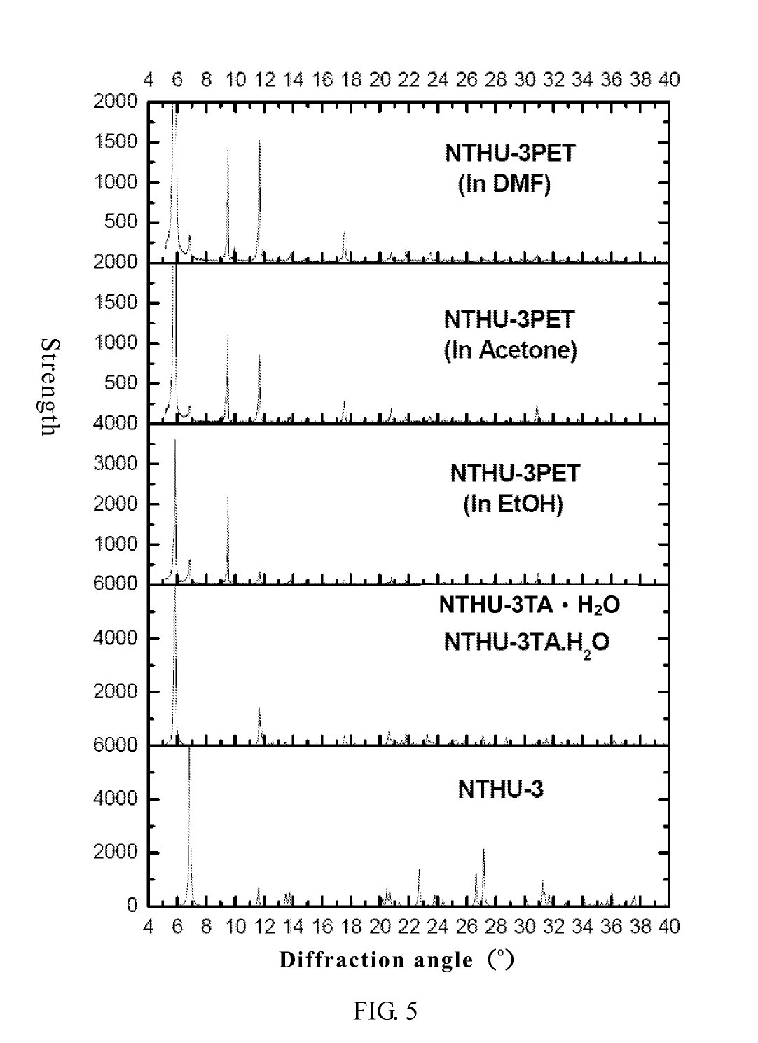

On the other hand, TA recycle can be done in different solvents by ultrasonic energy at the room temperature rather than by using strong acid by the conventional process. FIG. 5 illustrates an X-ray diffraction pattern of NTHU-3_{PET} made by the method 100. In the lower two graphs, they illustrate respectively the X-ray diffraction patterns of NTHU-3TA.H₂O and NTHU-3 which are made by conventional method and the upper three graphs illustrate the X-ray diffraction patterns of NTHU-3_{PET} powder which are dissolved respectively in dimethyl formamide (DMF), acetone and ethyl alcohol solution. The experimental conditions are generally that NTHU-3_{PET} is ground into powder and 0.04 g of the powder is put into different solvent (20 mL). Subsequently, the solution is vibrated by ultrasonic for 2 hours. As shown in FIG. 5, dimethyl formamide (DMF), acetone and ethyl alcohol are chosen to be solvents and NTHU-3_{PET} is mixed with the solvents. Partial NTHU-3_{PET} phase are transferred to NTHU-3 through ultrasonic energy. Thus, TA is recovered by the present invention.

The above descriptions are the preferred embodiments of the present invention. They are intended to explain the present invention but not to limit the range of the present invention. For brevity, some well known components of steps may not be illustrated. The range of the present invention should base upon the claims and their equivalences.

What is claimed is:

1. A method for manufacturing porous material from waste PET bottle, comprising:
reacting transition metal or d¹⁰ configuration metal source, amine source, polyethylene terephthalate (PET) source, phosphate source, and water in a close container under temperature between 120 to 200° C., and pressure between 1 to 100 atm for about 48 to 168 hours, for preparing a reaction mixture; and precipitating the porous material from said reaction mixture.

2. A method as claim 1 wherein said transition metal or d¹⁰ configuration metal source is zinc source.

3. A method as claim 2, wherein said zinc source is Zn, ZnCl₂, Zn(NO₃)₂.6H₂O or ZnO₂.

4. A method as claim 1, wherein said amine source is pyridine or alkyl polyamine source.

5. A method as claim 4, wherein said pyridine or alkyl polyamine source is Tris(2-aminoethyl)amine or 4,4′-trimethylenedipyridine.

6. A method as claim 1, wherein said porous material is (H₂TMDP)[Zn₂(HPO₄)₂(BDC)], related porous zinc phosphate or phosphite structures.

7. A method as claim 5, wherein said (H₂TMDP)[Zn₂(HPO₄)₂(BDC)] is a phosphor.

8. A method as claim 1, wherein said porous material is (H₃TREN)₂[Zn₃(PO₄)₂](TA)(H₂O)₂, related layered zinc phosphate or phosphite materials.

9. A method as claim 1, wherein said phosphate source is phosphoric acid, phosphorous acid, hypophosphorous acid.

10. A method as claim 1, wherein said reaction mixture is formed of solid reactants and water as a solvent

11. A method as claim 1, wherein said polyethylene terephthalate (PET) source is from waste bottle or reagent.

12. A porous material which is made by the method as claim 1, wherein said amine source is pyridine-like materials or alkyl polyamine.

13. A porous material which is made by the method as claim 12, wherein said pyridine-like materials is 4,4′-trimethylenedipyridine.

14. A porous material which is made by the method as claim 12, wherein said alkyl polyamine Tris(2-aminoethyl)amine.

15. A porous material which is made by the method as claim 1, wherein said transition metal or d¹⁰ configuration metal source is zinc source.

16. A porous material as claim 15, wherein said zinc source is Zn, ZnCl₂, Zn(NO₃)₂.6H₂O or ZnO₂.

17. A porous material which is made by the method as claim 1, wherein said porous material is (H₂TMDP)[Zn₂(HPO₄)₂(BDC)].

18. A porous material as claim 17, wherein said (H₂TMDP)[Zn₂(HPO₄)₂(BDC)] is a phosphor.

19. A porous material which is made by the method as claim 1, wherein said porous material is (H₃TREN)₂[Zn₃(PO₄)₂](TA)(H₂O)₂.

20. A porous material which is made by the method as claim 1, wherein said phosphate derivative source is phosphoric acid, phosphorous acid, hypophosphorous acid or hypophosphorous acid.

21. A porous material which is made by the method as claim 1, wherein said reaction mixture is an organic solvent.

22. A porous material which is made by the method as claim 1, wherein said polyethylene terephthalate (PET) source is from waste bottle or reagent.
